(19) United States
(12) Patent Application Publication
(10) Pub. No.: US 2009/0266507 A1
(43) Pub. Date: Oct. 29, 2009

(54) Heat exchanger, a method of making a heat exchanger and a kit

(75) Inventors: Jonathan Turnbull, West Yorkshire (GB); Michael Smith, West Yorkshire (GB); Mario Ciaffarafa, West Yorkshire (GB)

Correspondence Address: HARNESS, DICKEY & PIERCE, P.L.C., P.O. BOX 828, BLOOMFIELD HILLS, MI, 48303, US

(73) Assignee: DENSO MARSTON LTD., West Yorkshire (GB)

(21) Appl. No.: 12/378,789

(22) Filed: Feb. 19, 2009

(30) Foreign Application Priority Data
Apr. 23, 2008 (GB) 0807437.9

(51) Int. Cl. F28F 99/00; F28F 9/00; B23P 15/26

(52) U.S. Cl. 165/11.1; 165/47; 29/890.054

(57) ABSTRACT

A heat exchanger comprises a casing defining a chamber for liquid, an internal spacer inside the chamber and means for detecting the presence of the spacer. The detecting means may comprise an aperture in the casing to receive a projection on the spacer so that the projection can be seen.

### CROSS-REFERENCE TO RELATED APPLICATIONS

This application claims the benefit and priority of United Kingdom Patent Application No. 0807437.9, filed Apr. 23, 2008. The entire disclosure of the above application is incorporated herein by reference.

### FIELD

The invention relates to a heat exchanger, a method of making a heat exchanger and a kit.

### BACKGROUND

This section provides background information related to the present disclosure which is not necessarily prior art.

An example of a known heat exchanger is an oil cooler. A known prior oil cooler is described in EP-A-1593923. The oil cooler of EP-A-1593923 comprises a plurality of casings of elongate substantially flattened shape arranged in a stack. Each of the casings is formed from two half shells connected together along a peripheral strip thereof. The half shells are made of aluminum sheet. Aligned holes in the casings allow fluid communication between the casings. A corrugated plate or turbulator is arranged inside each casing and turbulators are also arranged between adjacent casings to increase the efficiency of heat exchange. Oil flows through the casings and air circulates between the casings to cool the oil. Two spacers are provided between adjacent casings, one spacer at each end of the casings. The spacer surrounds the hole through which adjacent casings communicate with each other and includes radial ribs.

The inventors have found when making a heat exchanger of large size, the weight of the stack of casings, together with the clamping pressure applied during brazing of the stack can lead to deformation of the oil chamber.

### SUMMARY

This section provides a general summary of the disclosure, and is not a comprehensive disclosure of its full scope or all of its features.

According to one aspect of the invention there is provided a heat exchanger comprising a casing defining a chamber for liquid, a spacer inside the chamber and means to enable detection of the presence of the spacer.

By placing a spacer inside the chamber, the spacer will resist collapse of the chamber or deformation of the chamber enabling a heat exchanger to be made which comprises a tall or heavy stack or which can resist clamping pressure without deformation. By providing means to enable detection of the presence of the spacer, it can be ensured that a spacer is always present and hence failure in manufacture is avoided and premature failure in use of the heat exchanger due to the absence of the spacer is also avoided.

The detection means may take any suitable form and may comprise means to enable visual detection of the spacer. In a preferred embodiment the wall of the liquid chamber defines at least one aperture enabling at least part of the spacer to be seen. This not only enables a visual check of whether a spacer is present, it also provides a leak path from the casing so that the heat exchanger will not pass a leak test in which the casing is pressurized. The liquid chamber may be elongate and the or at least one aperture may be in the end wall.

The casing defining the liquid chamber may be made of two parts which are attached together with the spacer between them. The or at least one aperture may be provided at the join between the two parts. The two parts may be brazed together. Preferably the or at least one aperture is defined by a rebate in each of the two parts. In this way, as well as acting as a visual indication of the presence of the spacer, the projection on the spacer also acts to locate the two parts with respect to one another.

The detection means in a preferred embodiment includes at least one projection on the spacer which protrudes into the or at least one aperture in the wall of the chamber so that it is visible. The outer end of the or each projection may lie flush with the outer surface of the wall of the liquid chamber, but preferably projects from the outer surface of the wall of the liquid chamber.

The detection means may include means to inhibit movement of the spacer and may include means to inhibit movement of the spacer away from the or at least one aperture. Preferably, the or at least one projection is shaped so that it cannot be withdrawn through the aperture. In this way, the spacer is held in place. The or at least one projection and the aperture in which the projection is received are preferably in complementary shapes. The or at least one projection may have a tapered shape. The or at least one projection may have a head connected to the main body of the spacer through a reduced width neck.

The or each projection is preferably at least 3 to 6 mm wide, most preferably at least 5 mm wide.

The heat exchanger may comprise a stack of casings with the liquid chambers arranged to communicate with one another. External spacers may be provided between adjacent casings in the stack.

In an alternative embodiment, the detection means comprises a leak orifice in the casing defining the chamber, the leak orifice being covered by the spacer. Thus, if the spacer is not present, the leak orifice is uncovered and there is a leak path from the chamber to outside. The heat exchanger can then be subject to a pressure test, and the leak resulting from the uncovered orifice will be detected thereby detecting the absence of the spacer. The liquid chamber may be elongate and the spacer may be arranged at one end.

In this embodiment, the heat exchanger preferably includes an external spacer to space two casings apart, the external spacer overlapping incompletely the position of the spacer inside the casing so as not to cover the orifice.

According to another aspect of the invention there is provided a heat exchanger comprising a casing defining a chamber for liquid, a spacer inside the chamber and at least one projection on the spacer received in a hole in the wall of the chamber to locate the spacer.

The hole may or may not be a through hole. The or each projection serves to locate the spacer.

The hole may be an existing hole with another function, such as the opening for communication with an adjacent casing, or may be a dedicated hole for the projection.

Preferably, the or at least one projection is shaped so that it cannot be withdrawn from the hole. In this way, the spacer is held in place. The or at least one projection and the hole in which the projection is received are preferably in complementary shapes. The or at least one projection may have a tapered shape. The or at least one projection may have a head connected to the main body of the spacer through a reduced width neck.

The or each projection is preferably at least 3 to 6 mm wide, most preferably at least 5 mm wide.

According to another aspect of the invention there is provided a kit of parts for brazing together to make a heat exchanger, the kit comprising two parts to be connected together to form a fluid chamber, a spacer to be placed between the two parts to be brazed to both of the parts, each of the parts including a flat peripheral surface to be brazed to a flat peripheral surface on the other part, one or both of the flat peripheral surfaces being interrupted by a rebate, the rebate or rebates forming an aperture when the flat peripheral surfaces of the parts are in contact, the spacer including a projection to sit in the aperture and be brazed to the surfaces defining the aperture.

Preferably, both of the flat peripheral surfaces are interrupted by a rebate. In this way, the projection on the spacer acts to locate the two parts with respect to one another.

The spacer may include a plurality of projections to be received in a plurality of rebates in the parts.

The or at least one projection and the aperture in which the projection is received are preferably in complementary shapes. The or at least one projection may have a tapered shape. The or at least one projection may have a head connected to the main body of the spacer through a reduced width neck.

The or each projection is preferably at least 3 to 6 mm wide, most preferably at least 5 mm wide.

The heat exchanger may be any suitable type of heat exchanger but in a preferred embodiment is an oil cooler.

The oil cooler may be for use in any suitable technical context, but is preferably for use in a vehicle, preferably an automotive vehicle, for cooling engine oil, or may be for use in a generator.

According to a further aspect of the invention there is provided a method of making a heat exchanger, the method comprising the steps of:
placing a first part so that a hollow defined in the part faces upwards surrounded by a flat peripheral surface; placing a spacer in the hollow in the part, stacking a second part on the first part so that a flat peripheral surface of the second part is in contact with the flat peripheral surface of the first part and such that a fluid chamber is defined between them; the spacer including a projection which is received in a rebate in one or both of the flat peripheral surfaces, the rebate or rebates forming an aperture when the flat peripheral surfaces of the parts are in contact; brazing the parts and the spacer together.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exploded perspective view of one end of the heat exchanger in the first embodiment;

FIGS. 2a and 2b are a plan view and perspective view of the internal spacer of the heat exchanger of the first embodiment;

FIGS. 3a and 3b are a plan view and respective view respectively of the external spacer of the heat exchanger of the first embodiment;

FIGS. 4a to c are a side elevation, plan view and perspective view of a gallery plate of the heat exchanger of FIG. 1 and FIG. 4d is a fragmentary detail perspective view of one end of the gallery plate;

FIG. 5 is an end view of the heat exchanger in the first embodiment;

FIGS. 6A and 6B are a plan view and perspective view respectively of an internal spacer in a second embodiment of the invention;

FIGS. 7A and 7B are a plan view and perspective view respectively of an internal spacer in another embodiment of the invention;

FIGS. 8A and 8B are a plan view and perspective view respectively of an internal spacer in a further embodiment of the invention;

FIG. 9 is a fragmentary detail perspective view from one end of a heat exchanger including the internal spacer of FIGS. 8A and 8B;

FIG. 10 is a fragmentary detail perspective view of a gallery plate in another embodiment;

FIG. 11 is a plan view of an internal spacer in the embodiment of FIG. 10; and,

FIG. 12 is a plan view of a heat exchanger in the embodiment of FIG. 10.

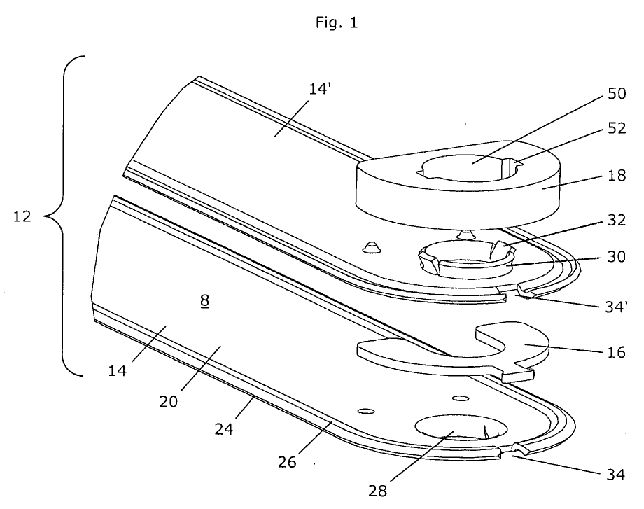

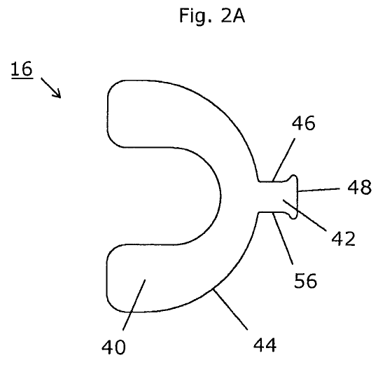

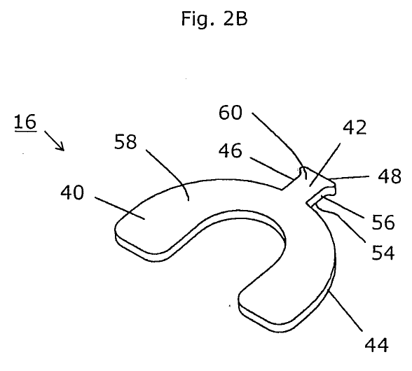

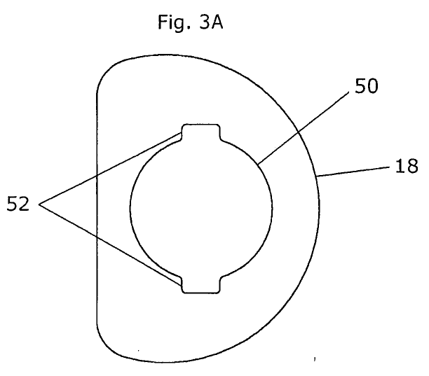

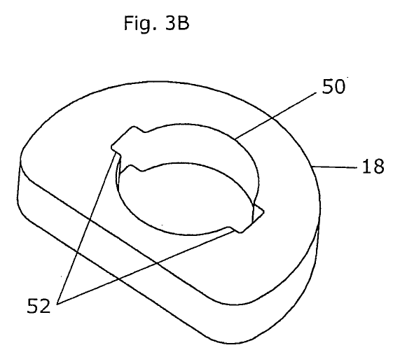

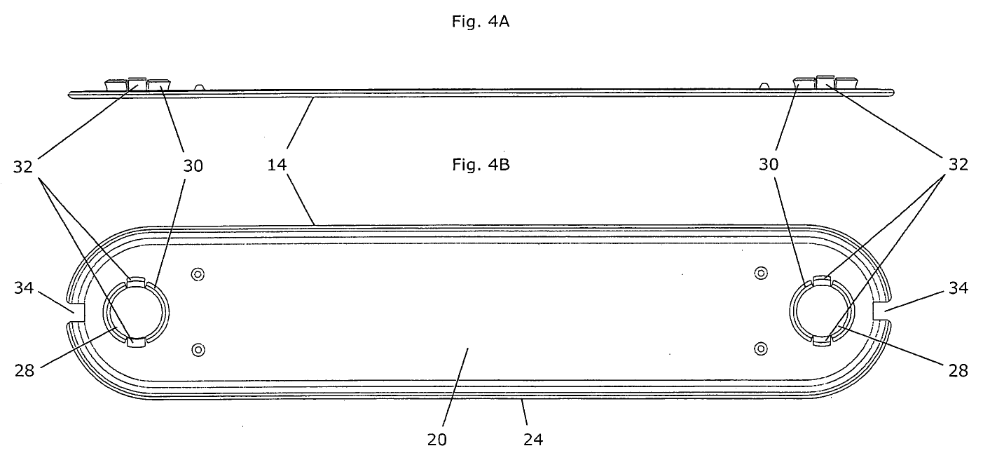

Corresponding reference numerals indicate corresponding parts throughout the several views of the drawings.

### DETAILED DESCRIPTION

Example embodiments will now be described more fully with reference to the accompanying drawings.

The heat exchanger 10 of the first embodiment of the invention comprises a plurality of casings 12 each made of two parts constituted by gallery plates 14. The heat exchanger 10 also includes internal spacers 16 and external spacers 18.

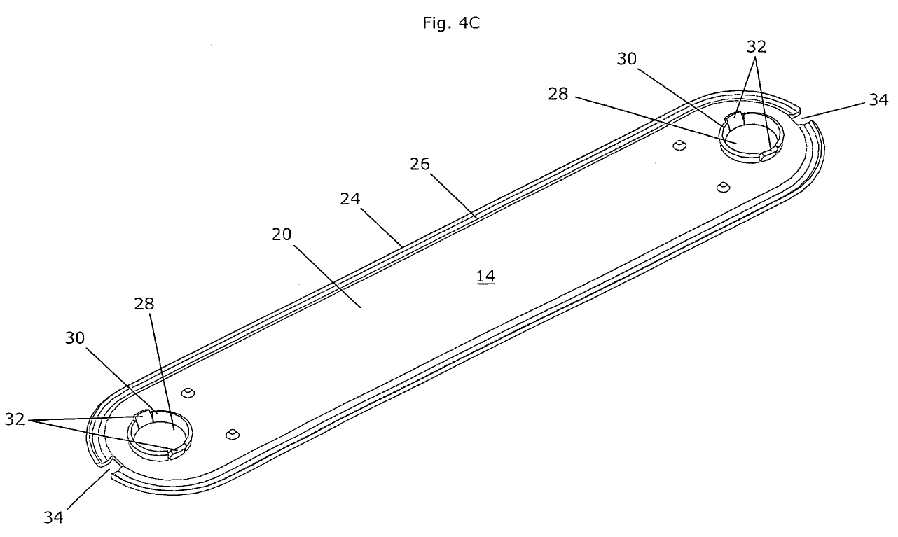

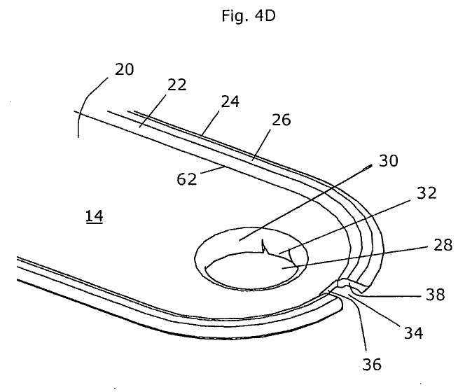

As shown in FIGS. 4A to 4D, each gallery plate 14 is in the form of a shallow tray with a floor 20, side wall 22 and around the top of the side wall 22 an outwardly extending flange 24 presenting an upwardly facing, flat, horizontal surface 26 around the periphery of the tray. At each end, the gallery plate 14 includes an opening 28 centrally in the floor 20 for connection to another casing 12. Each gallery plate 14 is made of sheet aluminum which is cut and then drawn into shape. Each opening 28 defines a downwardly extending rim 30 which is interrupted by two tabs 32. The tabs 32 are arranged in laterally opposed positions and are a little longer than the rim 30. At each end of the gallery plate 14, the peripheral surface 26 is interrupted by a square notch or rebate 34. The rebate 34 is thus defined by a portion 36 of the top of the side wall 22 and two parallel, straight, opposed edges 38 of the flange 24.

Each internal spacer 16 is flat and has a main body 40 which is generally C shaped in plan being dimensioned and shaped to fit in the hollow presented at the end of the tray shaped gallery plate 14 and partially surround the opening 28 in the gallery plate 14 without overlapping the opening 28. The internal spacer 16 includes a projection or tab 42 to fit into the rebate 34. The projection 42 extends substantially from the midpoint of the curve of outer edge 44 of the C shaped main body 40. The projection 42 is substantially T shaped and comprises a straight, parallel sided neck part 46 leading to a wider head part 48. The neck 46 is 5 mm wide.

Each external spacer 18 is generally of semicircular shape in plan and has a central bore 50 which is generally round in shape with opposed rectangular cut outs 52.

The gallery plates 14, internal spacers 16 and external spacers 18 are made of aluminum alloy, such as 3000 series alloy, clad with aluminum brazing alloy, such as 4000 series alloy.

To construct the heat exchanger 10 of the first embodiment, a gallery plate 14 is placed with the peripheral surface 26 facing upwards.

An internal spacer 16 is then placed on the floor 20 of the gallery plate 14 at each end in the hollow presented by the tray shaped gallery plate 14. The outer edge 44 of the main body 40 of the internal spacer 16 is complementary with and is located by the side wall 22 of the gallery plate 14 while the projection 42 is received in the rebate 34. The neck 46 of the projection 42 lies in the rebate 34 and the head 48 lies beyond the rebate 34 and is wider than the rebate 34. The lower surface 54 of the neck 46 contacts the portion 36 of the top of the side wall 22 of the gallery plate 14 and the side surfaces 56 of the neck 46 contact the opposed edges 38. The flat internal spacer 16 has greater depth than the depth of the hollow of the gallery plate 14 so that it stands proud of the gallery plate 14.

A second gallery plate 14′ is then arranged in an inverted position and placed on top of the first gallery plate 14. The floor 20 of the second gallery plate 14′ will contact the upper surface 58 of the internal spacer 16 and the peripheral surface 26′ of the second gallery plate 14′ will contact the peripheral surface 26 of the first gallery plate 14. At the rebate 34, the portion 36 of the top of the side wall 22 of the second gallery plate 14′ contacts the upper surface 60 of the neck 46, and the side surfaces 56 of the neck 46 contact the opposed edges 38′ of the flange 24′ of the second gallery plate 14′. The two gallery plates 14, 14′ thus form a casing 12 from which the head 48 of each internal spacer 16 protrudes. The casing 12 defines a chamber 8 between the gallery plates 14, 14′ for fluid.

An external spacer 18 is then placed on top of the second gallery plate 14′ at each end, the bore 50 in each external spacer 18 receiving the rim 30′ of the second gallery plate 14′ and the cut outs 52 receiving the tabs 32′ to locate the external spacer 18 on the casing 12 formed by the two gallery plates 14, 14′.

This sequence of placement of parts is then repeated to form a stack to the height required.

Turbulators (not shown) may be provided in the casings 12 and/or between the casings 12.

The assembled heat exchanger 10 can then be inspected.

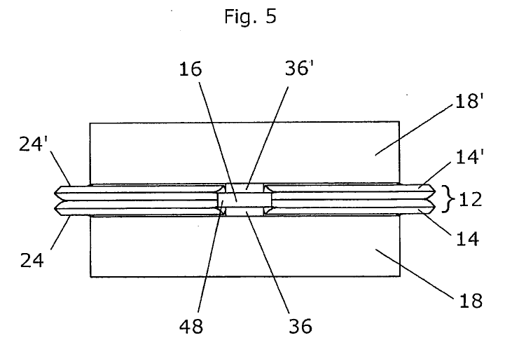

Visual inspection of the ends of the casings 12 will enable the absence of any internal spacers 16 to be detected by the absence of the protruding head 48 of an internal spacer 16 leaving an aperture in the casing 12. FIG. 5 shows a casing 12 including an internal spacer 16.

The assembly is then clamped vertically and brazed.

The peripheral surfaces 26, 26′ of the gallery plates 14, 14′ will braze together and it is seen that the gallery plates 14, 14′ will form a brazed seal around the neck 46 of the projection 42 of the internal spacer 16.

The completed heat exchanger 10 can then be pressure tested.

A pressure test will also reveal a missing internal spacer 16, because the missing spacer 16 will result in an aperture at the two rebates 34 and hence leakage.

The internal spacer 16 also serves to locate the gallery plates 14, 14′ one on the other. The internal spacer 16 locates the gallery plates 14, 14′ with respect to lateral movement. The internal spacer 16 also locates the gallery plates 14, 14′ with respect to axial movement due to the head 48.

The projection 42 also ensures that the internal spacer 16 is located correctly with respect to the gallery plates 14, 14′. The heat exchanger 10 may be assembled by hand, and an internal spacer 16 may be accidentally positioned too far back from the end of the gallery plate 14, or may be twisted, rather than placed symmetrically in the gallery plate 14. As the gallery plates 14, 14′ are drawn, they have a curved junction 62 between the floor 20 and the side wall 22. The internal spacer 16 can thus ride up the junction 62 and be incorrectly positioned laterally and/or axially. The requirement for the projection 42 to be received in the rebate 34 ensures that it is positioned correctly. In particular, the neck 46 of the projection 42 locates the internal spacer 16 laterally and the head 48 of the projection 42 together with the edge 44 of the spacer main body 40 locates the internal spacer 16 axially with respect to the gallery plate 14.

The heat exchanger 10 of the first embodiment may be used as an oil cooler in a large internal combustion engined vehicle. The construction is particularly suitable for large oil coolers and/or where there is high internal pressure.

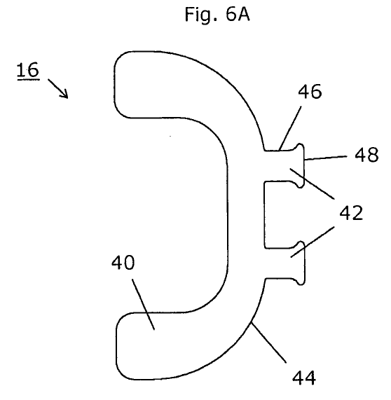

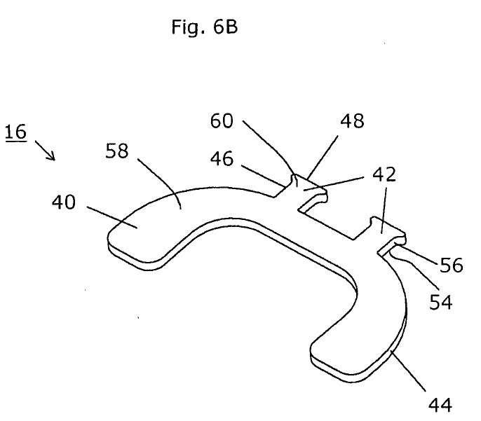

FIGS. 6A and 6B show an internal spacer 16 in a second embodiment. The same reference numerals will be used for equivalent features. Only the differences from the first embodiment will be described.

The internal spacer 16 of the second embodiment has two projections 42. It is thus more effective in locating itself and the gallery plates 14, 14′ and provides two indications, namely the two heads 48, of the presence of the spacer 16.

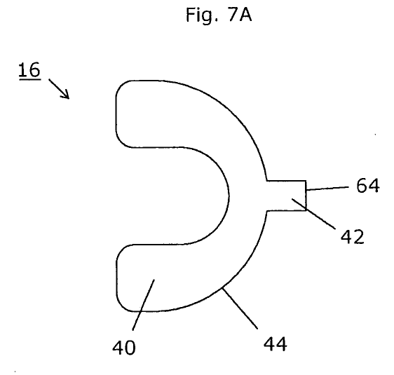

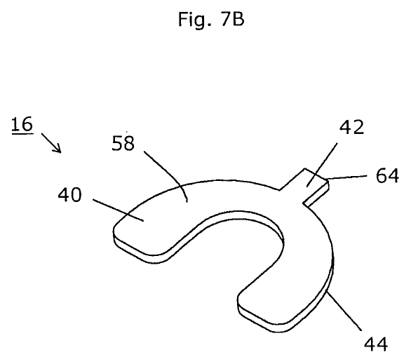

FIGS. 7A and 7B show an internal spacer 16 in another embodiment. The same reference numerals will be used for equivalent features. Only the differences from the first embodiment will be described.

The internal spacer 16 in this embodiment lacks the head 48 on the projection 42. The end 64 of the spacer 16 lies flush with the external surfaces of the flanges 24, 24′ of the gallery plates 14, 14′. The projection 42 thus provides a visual indication of the presence of the spacer 16 and serves to locate the spacer 16 and gallery plates 14, 14′ laterally.

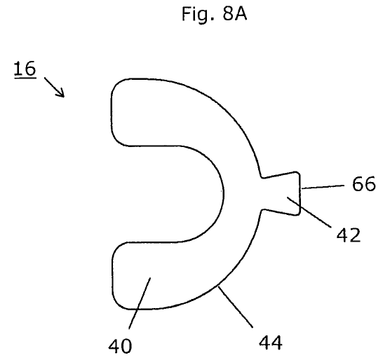

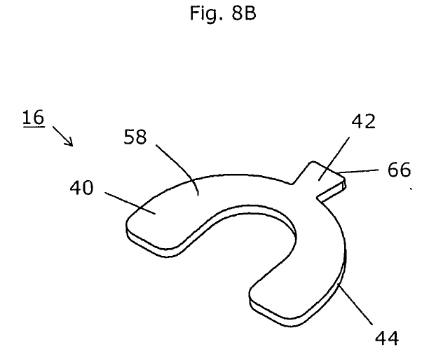

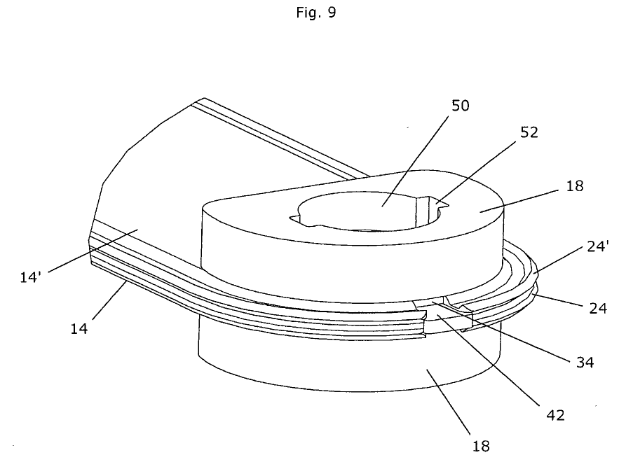

FIGS. 8A and 8B show an internal spacer 16 in a further embodiment. The same reference numerals will be used for equivalent features. Only the differences from the first embodiment will be described. The projection 42 in this embodiment is wedge shaped with the wider end 66 away from the main body 40 of the internal spacer 16. The rebate 34 is of a complementary wedge shape, so that the projection 42 of the internal spacer 16 is received as a good fit in dovetail fashion in the rebate 34. FIG. 9 shows the assembly. The projection 42 thus provides a visual indication of the presence of the spacer 16 and serves to locate the spacer 16 and gallery plates 14, 14′ both laterally and axially with respect to the gallery plates 14, 14′.

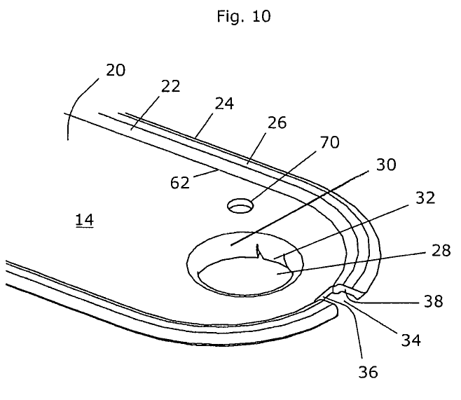

FIGS. 10, 11 and 12 show a heat exchanger in another embodiment. The same reference numerals will be used for equivalent features. Only the differences from the first embodiment will be described.

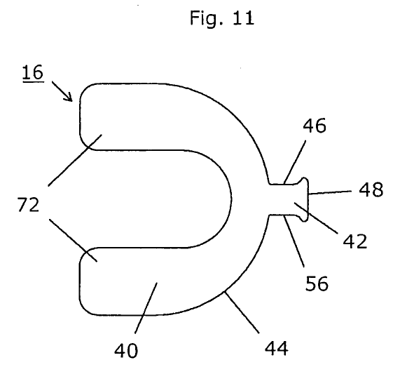

In this embodiment, there is an orifice 70 through the floor 20 of each gallery plate 14, the orifice being further from the end of the gallery plate 14 than the opening 28 and offset to one side, as shown in FIG. 10. The internal spacer 16 is of the same general shape as in the first embodiment, but the C shaped main body 40 has longer arms 72, as shown in FIG. 11.

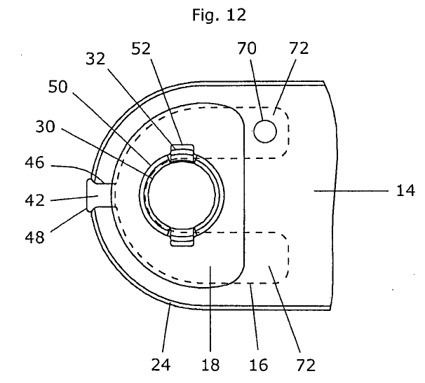

When the parts of the heat exchanger are assembled as shown in FIG. 12, the extended arms 72 of the internal spacer 16 overlap and cover the orifice 70 to block the orifice 70. The orifice 70 is so far back that it is not covered by the external spacer 18.

Thus, when the heat exchanger has been brazed, the pressure test will reveal if any internal spacers 16 have been omitted because the orifice 70 will form a leak path which will be detected.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A heat exchanger comprising a casing defining a chamber for liquid, a spacer inside the chamber and means for detecting the presence of the spacer.

2. The heat exchanger claimed in claim 1, wherein the detecting means comprises means for visually detecting the spacer.

3. The heat exchanger claimed in claim 2, wherein a wall of the liquid chamber defines at least one aperture enabling at least a part of the spacer to be seen.

4. The heat exchanger claimed in claim 3, wherein the liquid chamber is elongate and the at least one aperture is in an end wall.

5. The heat exchanger claimed in claim 3, wherein the casing defining the liquid chamber is made of two parts which are attached together with the spacer between them.

6. The heat exchanger claimed in claim 5, wherein the at least one aperture is provided at the join between the two parts.

7. The heat exchanger claimed in claim 6, wherein the at least one aperture is defined by a rebate in each of the two parts.

8. The heat exchanger claimed in claim 5, wherein the two parts are brazed together.

9. The heat exchanger claimed in claim 3, wherein the detecting means includes at least one projection on the spacer which protrudes into the at least one aperture in the wall of the chamber so that it is visible.

10. The heat exchanger claimed in claim 9, wherein an outer end of the at least one projection lies flush with an outer surface of a wall of the liquid chamber.

11. The heat exchanger claimed in claim 9, wherein an outer end of the at least one projection projects from an outer surface of a wall of the liquid chamber.

12. The heat exchanger claimed in claim 9, wherein the at least one projection is at least 3 to 6 mm wide.

13. The heat exchanger claimed in claim 9 wherein the at least one projection is at least 5 mm wide.

14. The heat exchanger claimed in claim 1, wherein the detecting means includes means for inhibiting movement of the spacer.

15. The heat exchanger claimed in claim 3, wherein the detecting means includes means for inhibiting movement of the spacer away from the at least one aperture.

16. The heat exchanger claimed in claim 9, wherein the at least one projection is shaped so that it cannot be withdrawn through the at least one aperture.

17. The heat exchanger claimed in claim 16, wherein the at least one projection and the at least one aperture in which the projection is received are in complementary shapes.

18. The heat exchanger claimed in claim 16, wherein the at least one projection has a head connected to a main body of the spacer through a reduced width neck.

19. The heat exchanger claimed in claim 16, wherein the at least one projection has a tapered shape.

20. The heat exchanger claimed in claim 1, wherein the heat exchanger comprises a stack of casings with the liquid chambers arranged to communicate with one another.

21. The heat exchanger claimed in claim 20, wherein external spacers are provided between adjacent casings in the stack.

22. The heat exchanger claimed in claim 1, wherein the detecting means comprises a leak orifice in the casing defining the chamber, the leak orifice being covered by the spacer.

23. The heat exchanger claimed in claim 22, wherein the liquid chamber is elongate and the spacer is arranged at one end of the elongated liquid chamber.

24. The heat exchanger claimed in claim 22, wherein the heat exchanger includes an external spacer to space two casings apart, the external spacer overlapping incompletely a position of the spacer inside the casing so as not to cover the leak orifice.

25. The heat exchanger claimed in claim 1, wherein the heat exchanger is an oil cooler.

26. A heat exchanger comprising:
a casing defining a chamber for liquid,
a spacer disposed inside the chamber and
at least one projection on the spacer received in a hole in a wall of the chamber to locate the spacer.

27. The heat exchanger claimed in claim 26, wherein the at least one projection is shaped so that it cannot be withdrawn from the hole.

28. The heat exchanger claimed in claim 27, wherein the at least one projection and the hole in which the projection is received are in complementary shapes.

29. The heat exchanger claimed in claim 27, wherein the at least one projection has a head connected to a main body of the spacer through a reduced width neck.

30. The heat exchanger claimed in claim 27, wherein the at least one projection has a tapered shape.

31. The heat exchanger claimed in claim 26, wherein the at least one projection is at least 3 to 6 mm wide.

32. The heat exchanger claimed in claim 26, wherein the at least one projection is at least 5 mm wide.

33. A kit of parts for brazing together to make a heat exchanger, the kit comprising:
two parts to be connected together to form a fluid chamber;
a spacer disposed between the two parts, brazed to both of the two parts wherein;
one of the two parts includes a flat peripheral surface brazed to a flat peripheral surface on the other of the two parts, one of the flat peripheral surfaces being interrupted by a rebate, the rebate forming an aperture when the flat peripheral surfaces of the parts are in contact, the spacer including a projection sitting in the aperture and brazed to surfaces defining the aperture.

34. The kit claimed in claim 33, wherein both of the flat peripheral surfaces are interrupted by a rebate.

35. The kit claimed in claim 34, wherein the spacer includes a plurality of projections received in a plurality of rebates in the two parts.

36. The kit claimed in claim 33, wherein the at least one projection and the aperture in which the projection is received are in complementary shapes.

37. The kit claimed in claim 33, wherein the projection has a head connected to a main body of the spacer through a reduced width neck.

38. The kit claimed in claim 33, wherein the projection has a tapered shape.

39. The kit claimed in claim 33, wherein the projection is at least 3 to 6 mm wide.

40. The kit claimed in claim 33, wherein the projection is at least 5 mm wide.

41. The kit claimed in claim 32, wherein the heat exchanger is an oil cooler.

42. A method of making a heat exchanger, the method comprising:
placing a first part so that a hollow defined in the first part faces upwards surrounded by a flat peripheral surface,
placing a spacer in the hollow in the first part,
stacking a second part on the first part so that a flat peripheral surface of the second part is in contact with the flat peripheral surface of the first part and such that a fluid chamber is defined between them, the spacer including a projection which is received in a rebate in one of the flat peripheral surfaces, the rebate forming an aperture when the flat peripheral surfaces of the first and second parts are in contact, and
brazing the first and second parts and the spacer together.
